(19) United States
(12) Patent Application Publication
(10) Pub. No.: US 2010/0030568 A1
(43) Pub. Date: Feb. 4, 2010

(54) Unused allocated mileage counter

(75) Inventor: Laith Daman, Livonia, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/221,057

(22) Filed: Jul. 29, 2008

(51) Int. Cl. G06Q 99/00

(52) U.S. Cl. 705/1

(57) ABSTRACT

A system for tracking mileage for a vehicle may include a controller, an input device and a mileage sensor. The input device may be adapted to receive a first predetermined allocated mileage rate and communicate the first predetermined allocated mileage rate to the controller. The mileage sensor may be adapted to sense a mileage value and communicate the mileage value to the controller. The controller may be adapted to determine an actual mileage rate based at least partially upon the mileage value and a predetermined time period. The controller may be adapted to determine a deviation between the actual mileage rate and at least one of the first predetermined allocated mileage rate and a second predetermined allocated mileage rate.

### FIELD

The present disclosure relates to a mileage counter and more particularly to an unused and/or exceeded allocated mileage counter for a vehicle.

### BACKGROUND

The statements in this section merely provide background information related to the present disclosure and may not constitute prior art. Many drivers, vehicle owners and vehicle lessees are concerned about the number of miles that their vehicles are driven because certain vehicles typically include contract lease or rental terms that limit the total distance the vehicle may be driven over the duration of a lease or rental term and include monetary penalties for exceeding the total distance or allocated mileage. Rising fuel prices may be a further source of concern about the number of miles driven and many drivers may attempt to limit the number of miles that their vehicles are driven to conserve fuel and therefore reduce their fuel expenses. Other concerns or curiosities of drivers, vehicle owners and lessees may give rise to a need or desire to monitor and/or budget vehicle mileage and the rate of mileage accumulation, such as miles driven per unit of time.

While vehicles typically include odometers displaying the total number of miles that the vehicle has ever been driven, budgeting the number of miles that the vehicle may be driven on a daily, weekly, monthly and/or annual basis is cumbersome. It becomes even more difficult to accurately track and budget mileage and mileage rates when multiple drivers use one vehicle. Without an effective means of budgeting mileage, many drivers are forced to significantly reduce their daily mileage or find alternative means of transportation near the end of the lease or rental term to avoid exceeding the total allocated mileage for the lease or rental to avoid incurring additional expenses and/or penalties. In light of the foregoing, there is a need in the art for effective and accurate means of counting and tracking unused and exceeded vehicle mileage.

### SUMMARY

The present disclosure provides a system for tracking mileage for a vehicle which may include a controller, an input device and a mileage sensor. The input device may be adapted to receive a first predetermined allocated mileage rate and communicate the first predetermined allocated mileage rate to the controller. The mileage sensor may be adapted to sense a mileage value and communicate the mileage value to the controller. The controller may be adapted to determine an actual mileage rate based at least partially upon the mileage value and a predetermined time period. The controller may be adapted to determine a deviation between the actual mileage rate and at least one of the first predetermined allocated mileage rate and a second predetermined allocated mileage rate.

The present disclosure also provides a method of tracking mileage of a vehicle which may entail inputting a first allocated mileage rate; calculating a second allocated mileage rate based on the first allocated mileage rate; counting actual miles driven during a first predetermined time period; calculating an actual mileage rate based on the actual miles driven and the first predetermined time period; and calculating a deviation between the actual mileage rate and one of the first and second allocated mileage rates. The deviation may then be communicated to a display device and displayed thereon.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of a vehicle having a system for counting unused and exceeded mileage according to the principles of the present disclosure; and

FIG. 2 is a flowchart illustrating a mode of operation of the system of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

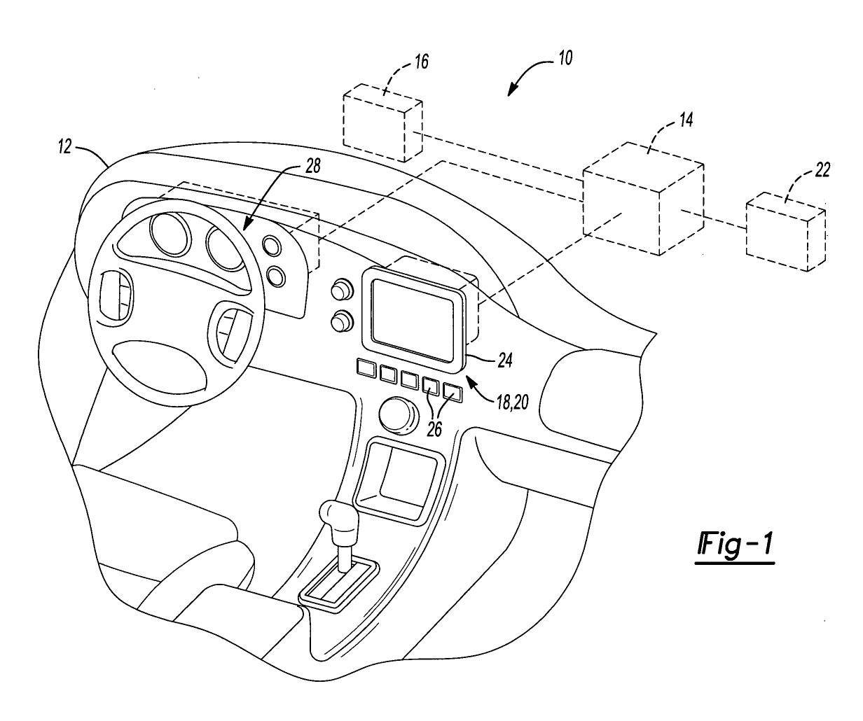

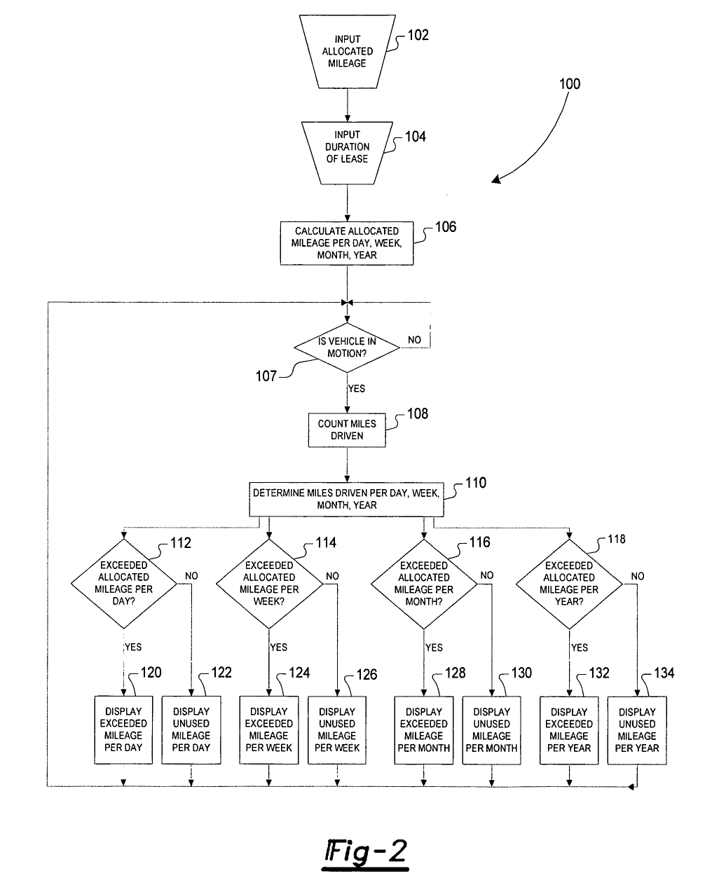

With reference to FIGS. 1 and 2, a system for counting and tracking mileage is provided and is generally referred to as the system 10. The system 10 may be disposed in a vehicle 12 and may include a controller 14, a mileage sensor 16, a user input device 18 and a display device 20. The system 10 counts the number of miles which a vehicle 12 travels over a calculated distance or time period, calculates one or more mileage rates, calculates a deviation between the one or more mileage rates and one or more allocated mileage rates, and displays the deviation in the form of exceeded mileage and/or unused mileage, as will be subsequently described.

The vehicle 12 may be any type of vehicle including an automotive vehicle, as shown in FIG. 1, and with respect to an individual person or driver, may be an owned vehicle, a leased vehicle, a rented vehicle, or a borrowed commercial fleet vehicle, for example. A driver's possession of such a vehicle may be conditioned upon the vehicle being driven no more than a predetermined allocated mileage (such as 12,000 miles per year, for example) and the vehicle driver or vehicle owner may be subject to monetary penalties and/or fees for actual accrued mileage that exceeds the predetermined allocated mileage. It will be appreciated that the principles of the present disclosure are not limited to such vehicles. For example, the predetermined allocated mileage could also be a mileage for a vehicle that a driver or vehicle owner desires to remain below to reduce fuel consumption, wear and tear, and/or depreciation of the vehicle 12.

The controller 14 is in communication with the mileage sensor 16, the user input device 18 and the display device 20, and may be any suitable microprocessor-based controller, for example. The controller 14 may be disposed in any suitable location within the vehicle 12 and may also be associated with other known intelligent vehicle systems, such as vehicle control systems, vehicle information systems and/or vehicle diagnostic systems, for example. The controller 14 may include a memory storage device 22. The memory storage device 22 may be a non-volatile memory device which is operable to save information stored therein for later retrieval. The controller 14 may also include an internal clock or timer to track days, weeks, months and years, for example. It should be appreciated that the controller 14 may communicate with any suitable time keeping device of the vehicle 12, internal or external, to track days, weeks, months and years.

The mileage sensor 16 may be any suitable device known in the art to be operable to sense vehicle motion and measure or calculate a distance (or mileage) which the vehicle 12 travels along a road surface. For example, the mileage sensor 16 may detect the number of rotations of one or more tires or wheels of the vehicle 12, which may be subsequently converted or equated to a linear distance traveled. Alternatively, the mileage sensor 16 may be a GPS (Global Positioning System) unit adapted to detect mileage of the vehicle 12 via satellite communication, as satellites and a GPS may measure distances via positioning of a transponder in a vehicle 12 on the ground. While the vehicle 12 is in motion, the mileage sensor 16 may continuously or intermittently communicate mileage values to the controller 14.

The user input device 18 may be, or may be part of, a known intelligent device on board the vehicle 12, such as an on-board navigation system 24 or other vehicle information or control system, for example that is capable of receiving input from a human hand, for instance. The navigation system 24 may include mechanical buttons 26 and/or a touch screen user interface such that a human hand may enter numerical values, for instance. A user may actuate the buttons 26 or touch screen interface to input an allocated mileage of vehicle 12, such as a total number of miles that the vehicle 12 may be driven over the term of the lease without a penalty being imposed. The user may also input a lease term, or duration, in days, weeks, months, or years or a lease termination date. The navigation system 24 or controller 14 may store the present date and therefore in conjunction with the lease termination date, calculate the time or days remaining in a lease term. The allocated mileage and duration may be predetermined by the terms or details of the lease agreement. The user input device 18 may then communicate such information to the controller 14, where it may then be stored in the memory storage device 22.

It should be appreciated that the input device 18 could be independent from the vehicle 12. For example, a diagnostic tool or other communication device could be linked via wired or wireless communication with the controller 14 to input allocated mileage and the lease duration. Such communication may be communicated from inside an office building to a vehicle and even each vehicle in a fleet of vehicles.

The display device 20 is in communication with the controller 14 and may be any vehicle information display system such as, for example, the navigation system 24, a display disposed on an instrument cluster 28, a heads-up display unit (not shown), or any other suitable device for displaying vehicle information to a driver or passenger. As will be subsequently described, the display device 20 may display the daily, weekly, monthly and/or annual used mileage, exceeded mileage, and/or unused mileage of the vehicle 12. The display device 20 may also be in communication with the user input device 18 and may allow the user to selectively display the parameters input into the system 10 (e.g., allocated mileage and lease duration), exceeded mileage and/or unused mileage.

It should be appreciated that the user input device 18 and/or the display device 20 can be disposed outside of the vehicle 12. For example, the user input device 18 and/or display device 20 may communicate with the controller 14 via a wireless communication link, such as a wireless internet connection. In such a configuration, a user may access a webpage to input allocated mileage and duration of the lease which may then be communicated to the controller 14. The user may also access the webpage to view a display of used mileage, exceeded mileage and/or unused mileage of the vehicle 12. It should be understood that the input device 18 and the display device 20 can be independent modules or integrated into a single module.

With continued reference to FIGS. 1 and 2, operation of the system 10 will be described in detail. As described above, the allocated mileage and a length of time over which the vehicle 12 may drive or consume the allocated mileage (or a lease or rental termination date) may be input into, or via, the user input device 18 and subsequently communicated to the controller 14. The controller 14 may calculate allocated daily, weekly, monthly and annual mileage rates and communicate the allocated mileage rates to the memory device 22 to be stored therein.

When the vehicle 12 is in motion with its wheels turning, the mileage sensor 16 may sense the actual mileage that the vehicle 12 has driven, such as by using the rotation of the wheels, or a GPS as described above. The actual mileage is communicated to the controller 14 and the memory storage device 22 either continuously or intermittently. The controller 14 may track the number of miles that the vehicle 12 has driven over a predetermined time period, e.g., a day, week, month and year, as examples. The controller 14 may then calculate the actual mileage rate that the vehicle 12 has driven per day, week, month and/or year.

The controller 14 may then compare the actual daily, weekly, monthly and annual mileage rates with the respective allocated daily weekly, monthly and annual mileage rates and quantify mileage deviations therebetween. The mileage deviation may be displayed as an unused mileage if the actual mileage rate for the predetermined time period is less than the allocated mileage rate for the respective predetermined time period. The mileage deviation may be displayed as an exceeded mileage if the actual mileage rate for the predetermined time period is greater than the allocated mileage rate for the respective predetermined time period. For example, if any of the actual mileage rates exceed the respective allocated mileage rate for any predetermined time period (i.e., for any of a day, week, month, and year), the controller 14 may cause the display device 20 to display the exceeded mileage value for that predetermined time period, where the exceeded mileage value is equal to the difference between the actual mileage and the allocated mileage. When the display device 20 displays an exceeded mileage value for any of the predetermined time periods, the display device 20 may also actuate a warning signal to alert the driver of the vehicle 12 that the allocated mileage for one or more of the predetermined time periods has been exceeded. The warning signal may be a visual signal displayed on the display device 20 or any other suitable visual signal. Additionally or alternatively, the warning signal can be an audible signal, such as a warning tone of the type commonly employed to warn a driver of a low fuel condition, for example.

The controller 14 may selectively calculate the mileage deviation in a fixed mode or a dynamic mode. The user may select the fixed mode or the dynamic mode via the user input device 18, for example. In the fixed mode, if any of the actual mileage rates are less than any of the respective allocated mileage rates for a particular predetermined time period, the controller 14 may cause the display device 20 to display an unused mileage value for that predetermined time period, where unused mileage is equal to the difference between the allocated mileage and the actual mileage for the particular predetermined time period, as described above. If any of the actual mileage rates are greater than any of the respective allocated mileage rates for a particular predetermined time period, the controller 14 may cause the display device 20 to display an exceeded mileage value for that predetermined time period, where exceeded mileage is equal to the difference between the actual mileage and the allocated mileage for the particular predetermined time period, as described above.

In the dynamic mode, the controller 14 may account for the mileage deviation (i.e., unused or exceeded mileage) of any past time periods (if applicable) in the calculation of current exceeded or current unused mileage for the predetermined time period. The following equation illustrates the mileage deviation value for a current predetermined time period T calculated in the dynamic mode:

Mileage deviation for predetermined time period T=(allocated miles per the predetermined time period T)−(actual miles driven for the predetermined time period T)+(mileage deviation for a predetermined time period (T-1))+(mileage deviation for a predetermined time period (T-2))+(mileage deviation for a predetermined time period (T-3))+ . . . +(mileage deviation for a predetermined time period 1),

where the predetermined time period 1 may be the first predetermined time period during which the vehicle 12 has been driven. It should be appreciated that the equation above includes the addition of mileage deviations for predetermined time periods (T-1), (T-2), (T-3), etc. to illustrate that the calculation of mileage deviation in the dynamic mode includes the sequential addition of any mileage deviations for any past predetermined time periods, if any, where (T-1) is a predetermined time period immediately preceding the predetermined time period T (if applicable), (T-2) is a predetermined time period immediately preceding the predetermined time period (T-1) (if applicable), and (T-3) is a predetermined time period immediately preceding the predetermined time period (T-2) (if applicable). If the above equation yields a positive number, the mileage deviation for the predetermined time period T may be displayed as unused mileage. If the above equation yields a negative number, the mileage deviation for the predetermined time period T may be displayed as exceeded mileage. Mileage deviations for current and past predetermined time periods may be stored in the memory storage device 22 to be subsequently retrieved and included in the dynamic mode calculation of unused and/or exceeded mileage rates.

Additionally or alternatively, the controller 14 may be adapted to determine an average mileage value for a plurality of consecutive predetermined time periods. The controller 14 may then calculate an exceeded mileage or unused mileage for the one or more predetermined time periods if the average mileage is above or below the allocated mileage for the one or more predetermined time periods, respectively. The user may selectively cause the controller 14 to communicate the average mileage and/or exceeded or unused mileage based on the average mileage to the display device 20 to be displayed thereon.

Additionally or alternatively, the controller 14 may be adapted to determine an extrapolated mileage value for one or more of the predetermined time periods. For example, the controller 14 may calculate an extrapolated weekly, monthly and/or annual mileage based on an actual daily mileage value, whereby the actual daily mileage rate may be multiplied by seven, thirty and/or 365 to determine the extrapolated weekly, monthly and annual mileage, respectively, based on a current pace of accrual of actual daily mileage. The user may selectively cause the controller 14 to communicate the extrapolated mileage to the display device 20 to be displayed thereon. The extrapolated mileage shows the driver how many miles above or below the weekly, monthly or annual allocated mileage that the vehicle mileage will be if the vehicle 12 is driven the actual daily mileage everyday for the remainder of the lease term.

With reference to the flowchart of FIG. 2, a method 100 of tracking mileage of the vehicle 12 may entail: inputting a first allocated mileage rate (block 102); inputting the duration of a vehicle lease (block 104); calculating a second allocated mileage rate based on the first allocated mileage rate (block 106); counting actual miles driven during a first predetermined time period (block 108) once it is determined that the vehicle 12 is in motion (block 107); calculating an actual mileage rate based on the actual miles driven and the first predetermined time period (block 110); and calculating a deviation between the actual mileage rate and one of the first and second allocated mileage rates (e.g., blocks 112, 114, 116 and/or 118). It should be appreciated that inputting a first allocated mileage rate can include inputting an allocated mileage and inputting a lease duration, for example.

The method 100 may also include storing the counted actual miles in the memory storage device 22; storing one or more mileage deviations (i.e., unused and/or unused mileage) in the memory storage device 22; selecting either the fixed mode or dynamic mode of calculating mileage deviations; communicating one or more mileage deviations to the display device 20 and displaying the one or more mileage deviations thereon (blocks 120, 122, 124, 126, 128, 130, 132 and/or 134); and actuating the warning signal in response to the actual mileage rate being greater than at least one of the first allocated mileage rate and the second allocated mileage rate.

Although the system 10 and method 100 are described herein with reference to miles travelled and mileage, it should be appreciated that the principles of the present disclosure are equally applicable to any unit of measuring distance, such as, for example, kilometers, meters, feet, inches or any other unit of distance. Accordingly, for purposes of the present disclosure, the term “mile” is used to refer to any unit of distance, and the term “mileage” is used to refer to the accumulation of any unit of distance traveled. It should also be appreciated that the principles of the present disclosure are not limited to automotive vehicles. The system 10 and method 100 are equally applicable to any type of vehicle including, for example, a motorcycle, a recreational vehicle, a watercraft or an aircraft.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A system comprising:
a controller;
an input device adapted to receive, from a human hand, a first predetermined allocated mileage rate and communicate the first predetermined allocated mileage rate to the controller; and
a mileage sensor adapted to sense a mileage value and communicate the mileage value to the controller,
wherein the controller is adapted to determine an actual mileage rate based upon the mileage value and a predetermined time period, and wherein the controller is adapted to determine a deviation between the actual mileage rate and at least one of the first predetermined allocated mileage rate and a second predetermined allocated mileage rate.

2. The system according to claim 1, further comprising a display device in communication with the controller, the display device adapted to display the deviation.

3. The system according to claim 1, wherein the controller calculates the deviation in at least one of a fixed mode and a dynamic mode.

4. The system according to claim 1, wherein:
the predetermined time period is one of a day, a week, a month and a year, and
the mileage value is stored in a memory device in communication with the controller.

5. The system according to claim 1, wherein the mileage value is continuously updated while a vehicle is in motion.

6. The system according to claim 1, wherein the deviation is displayed as an exceeded mileage rate in response to the actual mileage rate being greater than at least one of the first and second predetermined allocated mileage rates.

7. The system according to claim 1, wherein the controller is adapted to cause a warning signal to be actuated in response to calculation of an exceeded mileage rate.

8. The system according to claim 1, wherein the deviation is displayed as an unused mileage rate in response to the actual mileage rate being less than at least one of the first and second predetermined allocated mileage rates.

9. The system according to claim 1, wherein the second predetermined mileage rate is a daily allocated mileage value.

10. A method of tracking mileage of a vehicle comprising:
inputting, by a human hand, a first predetermined allocated mileage rate;
calculating a second allocated mileage rate based on the first predetermined allocated mileage rate;
counting actual miles driven during a first predetermined time period, which is one of a day, a week, a month and a year, and storing the counted actual miles in a memory storage device;
calculating an actual mileage rate based on the actual miles driven and the first predetermined time period;
calculating a deviation between the actual mileage rate and one of the first and second allocated mileage rates; and
storing the deviation between the actual mileage rate and one of the first and second allocated mileage rates in a memory storage device.

11. The method of tracking mileage according to claim 10, further comprising communicating the deviation to a display device and displaying the deviation thereon.

12. The method of tracking mileage according to claim 11, wherein displaying the deviation further comprises displaying at least one of an exceeded mileage rate and an unused mileage rate.

13. The method of tracking mileage according to claim 12, further comprising:
actuating a warning signal in response to the actual mileage rate being greater than at least one of the first allocated mileage rate and the second allocated mileage rate.

14. The method of tracking mileage according to claim 13, further comprising selecting one of a fixed mode and a dynamic mode.

15. The method of tracking mileage according to claim 14, wherein the dynamic mode accounts for miles driven during a second predetermined time period.

16. The method of tracking mileage according to claim 15, wherein the second predetermined time period is one of a day, a week, a month and a year.

17. A method of tracking mileage of a vehicle comprising:
inputting, by a human hand, a first predetermined allocated mileage rate into a user input device;
inputting, by a human hand, a vehicle lease duration into the user input device;
calculating a second allocated mileage rate based on the first predetermined allocated mileage rate;
counting actual miles driven during a first predetermined time period, which is one of a day, a week, a month and a year, and storing the actual miles driven in a memory storage device;
calculating an actual mileage rate based on the actual miles driven and a first predetermined time period;
calculating a deviation between the actual mileage rate and one of the first and second allocated mileage rates; and
storing the deviation between the actual mileage rate and one of the first and second allocated mileage rates in a memory storage device.

18. The method of tracking mileage of a vehicle of claim 17, further comprising: selecting a fixed mode, by a human hand using a user input device, and if an actual mileage rate is less than a respective allocated mileage rate for a particular predetermined time period, displaying an unused mileage value for that predetermined time period, wherein unused mileage is equal to a difference between the allocated mileage and the actual mileage for a particular predetermined time period.

19. The method of tracking mileage of a vehicle of claim 17, further comprising:
selecting a fixed mode, by a human hand using a user input device, and if any of the actual mileage rates are greater than any of the respective allocated mileage rates for a particular predetermined time period, displaying an exceeded mileage value for that predetermined time period, wherein exceeded mileage is equal to a difference between the actual mileage and the allocated mileage for a particular predetermined time period.

20. The method of tracking mileage of a vehicle of claim 17, further comprising:
selecting a dynamic mode, by a human hand using a user input device, and calculating a mileage deviation (i.e., unused or exceeded mileage) of a past time period, for use in calculating a current exceeded or current unused mileage for the predetermined time period, according to: Mileage deviation for the predetermined time period T=(allocated miles per the predetermined time period T)−(actual miles driven for the predetermined time period T)+(mileage deviation for a predetermined time period (T-1))+(mileage deviation for a predetermined time period (T-2))+(mileage deviation for a predetermined time period (T-3))+ . . . +(mileage deviation for a predetermined time period 1), wherein the predetermined time period 1 may be the first predetermined time period during which the vehicle has been driven.
